(19) United States
(12) Patent Application Publication
(10) Pub. No.: US 2007/0297301 A1
(43) Pub. Date: Dec. 27, 2007

(54) Method And Device For Automatic Disc Skew Correction

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,958

(22) PCT Filed: Nov. 25, 2005
(86) PCT No.: PCT/IB05/53901

§ 371 Date: May 23, 2007

(30) Foreign Application Priority Data
Nov. 30, 2004 (EP) 04106186.2

(51) Int. Cl. G11B 7/095

(52) U.S. Cl. 369/44.32

(57) ABSTRACT

A method and device for controlling disc run out in an optical disc drive system. The drive has a rotatable axle (7) and holding means (6) for holding a disc (2, 136) so that the normal of the disc is essentially parallel to the axle. A tilt mechanism is arranged at the holding means for tilting the disc. A collection unit (10) is arranged at the optical disc drive for reading information from or writing information to the disc. A servo means (132) maintains the collection unit at a distance (133) from the disc. The servo means generates a control signal (134) provided to an actuator (130) for lenses in the collection unit. The control signal has a DC component and an AC component having a periodicity corresponding to the rotational speed of the disk and an amplitude related to the distance. The control signal is fed to the tilt mechanism. The tilt mechanism is adjusted in an X-direction and a Y-direction for minimizing the amplitude of the control signal.

The present invention relates to an optical disc system, comprising an optical pickup device for writing and/or reading information to and/or from any kind of optical disc-like storage medium, such as CD or DVD. The optical pickup device is moving in a radial direction along the surface of the rotating optical disc.

The maximum data density that can be recorded on an optical disc in an optical disc system inversely scales with the size of the laser spot that is focused onto the disc. The spot size is determined by the ratio of two optical parameters: the wavelength, λ, of the laser and the numerical aperture, NA, of the objective lens.
Focused spot size(FWHM)=1.22*λ/NA (1)

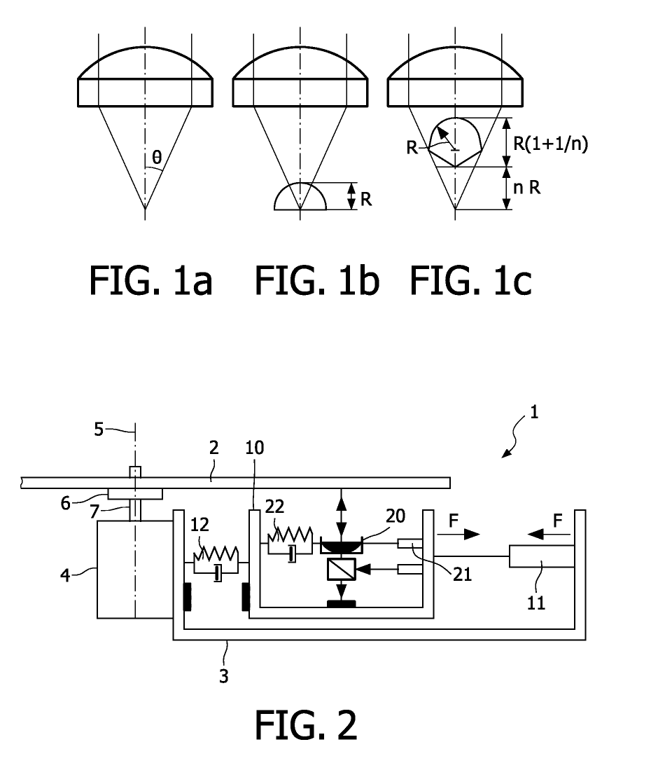

The NA of an objective lens is defined as NA=n*sin(θ), where n is the refractive index of the medium in which the light is focused and θ is the half angle of the focused cone of light in that medium. It is evident that the upper limit for NA of objective lenses that focus in air (FIG. 1a) or through a plane parallel plate (like a flat disc) is unity. The NA of a lens can exceed unity if the light is focused in a high index medium without refraction at the air-medium interface, for example by combining the focusing lens with a hemispherical solid immersion lens, SIL, (FIG. 1b). The light beam is focused towards the center of the SIL. In this case the effective NA is Na_{eff}=n*NAₒ with n the refractive index of the SIL and NAₒ the NA in air of the focusing lens. A third option to further increase the NA is the use of a super-hemispherical lens (FIG. 1c) in which the beam is refracted towards the optical axis by the super-hemispherical lens. In the latter case the effective NA is N_{eff}=n²Aₒ. It is important to note that an effective NA_{eff} larger than unity is only present within an extremely short distance, the so called near-field, from the exit surface of the SIL, typically smaller than 1/10^{th} of the wavelength of the light. This means that during writing or read-out of an optical disc, the distance between the SIL and the disc must at all times be smaller than of few tens nanometers.

To maintain this very small distance during read and write operations, a dedicated servo system and a suitable gap error signal (GES) have to be used, see e.g. F. Zijp et al in Proc. ODS 2004. Such a servo system has a limited bandwidth and therefore needs to be designed for a certain allowed residual gap error, typically 2 nm. The required bandwidth to reach this value depends on the rotation speed (for higher speeds it is more difficult to follow any ‘vertical’ disturbance) and the maximum vertical disc displacement (larger displacement is more difficult). Clearly, the maximum vertical displacement should be minimized to allow for the highest rotation speed and therefore also the highest data transfer rates.

In general it is desired that the optical disc is clamped correctly and in a predetermined position on a turntable, so that the optical disc is moving in a flat plane during rotation, which plane extends in radial direction with respect to the axis of rotation of the turntable. Then, the optical pickup device moves along its radial directed path, whereby the distance between the optical pickup device and the surface of the optical disc remains the same.

However, there are several reasons why the optical disc may not rotate exactly in said flat radial directed plane. A first reason is the possible presence of unwanted particle material on the turntable, so that the clamping means cannot push the optical disc correctly against the surface of the turntable, or incorrect clamping of the optical disc otherwise. In that case the optical disc will be clamped in a tilting position with respect to the turntable. This may result in an oscillation in axial direction of the edge of the optical disc during its rotation and seen from a stationary location, whereby the frequency of the oscillation is equal to the rotational speed (expressed in revolutions per second) of the optical disc.

The vertical displacement of the disc, called run out, is first of all determined by the flatness of the disc. If the disc is warped or twisted, this leads to large run outs. As an example, Silicon wafers of 15 cm (6 inches) diameter have an intrinsic run out better than about 5 μm, whereas polycarbonate discs for the recent Blu-ray Disc standard (12 cm diameter) are specified to have a run out of 100 μm or less. Secondly, the run out is determined by the disc mounting or clamping mechanism in the drive. If the mount or clamp causes the disc to be slightly tilted with respect to the motor axis, called disc skew (angle of disc normal to motor axis), even a perfectly flat disc will show considerable run out (see FIG. 2). To quantify this effect an example is given; a perfectly flat 12 cm disc (r=6 cm) with a disc skew of 0.1° (=1.75 mrad) will show a run out as large as 330 μm near its edge.

In near field optical disc systems, the disc skew needs to be minimized in order to reach acceptable data transfer rates using a practical focus actuator and servo system. As an example, an optical disc system, with a realistic bandwidth, is aimed at 1200 rpm (rotations per minute) and has a residual gap error of ±2 nm or less. With a well-designed control system and a good actuator, this corresponds to a maximum-allowed run out of ±10 μm. The result is that for a flat disc with a diameter of 12 cm, the skew should be less than 0.1 mrad or 0.006°.

In conventional systems, mechanical tilt corrections can be used to improve the system improvement for discs with large tilt, e.g. due to warping or poor clamping. Corrections of disc tilt can be done in a few ways.

U.S. Pat. No. 5,412,640 discloses a method for generating a regulating or measuring signal in order to regulate or measure the tangential and radial angles of the light beam arranged for reading data on a rotating recording medium. The light beam is reflected from the recording medium onto a photo detector the output of which represents the data signal. The data signal is demodulated in an amplitude demodulator and the regulating or measuring signals are generated from the amplitude and the phase position of the demodulated data signal. Separate measurement devices as a photo detector increase the costs and make the construction unhandy.

WO 2004/01851 A1 discloses a measuring method capable of providing a measuring signal directly indicative of radial vibration of the mechanism. This method does not compensate for axial deviations.

Purely mechanical solutions are both too large and expensive (motor axis diamond turned together with a big clamping area) or not accurate enough. Therefore, an automatic correction method is required, as well as a suitable gap error signal for the run out.

The object of the present invention is to provide a device and a method for compensating for axial deviations of a disc such as occur at non-alignment of the axis of the disc in relation to the axis of the drive resulting in wobbling of the disc.

In an aspect of the invention, there is provided a device for controlling disc run out in an optical disc drive system, comprising: a rotatable axle; a holding means arranged at said axle for holding a disc so that a normal of the disc is essentially parallel to said axle; a tilt means arranged at said holding means for tilting the disc; a collection unit arranged at the optical disc drive for reading information from or writing information to the disc; and a servo means for maintaining said collection unit at a distance from said disc, said servo means producing a control signal. Control means are provided for controlling the tilt means by means of said control signal for adjustment of the normal of the disc to be parallel to said axle.

According to an embodiment of the invention, the control signal is a signal having a DC component and an AC component having a periodicity corresponding to a rotation speed of said disc and an amplitude related to said distance. The control means may control said tilt means in a first and second direction for minimizing said amplitude. The control means may control the tilt means in an X-direction for minimizing said amplitude and then in a Y-direction for further minimizing said amplitude, and optionally repeating this procedure.

In another embodiment of the invention, the collection unit may comprise a light source, such as a laser, and a lens assembly for directing a beam of said light source at said disc. The lens assembly may comprise a solid immersion lens being controlled to be very close to the surface of said disc by an actuator controlled by an error signal.

In another aspect of the invention, there is provided a method of controlling disc run out in an optical disc drive system, in which said optical disc drive system comprises: a rotatable axle; a holding means arranged at said axle for holding a disc so that a normal of the disc is essentially parallel to said axle; a tilt means arranged at said holding means for tilting the disc; a collection unit arranged at the optical disc drive for reading information from or writing information to the disc. The method comprises maintaining said collection unit at a distance from said disc by means of a servo system producing a control signal; and providing said control signal to said tilt means for adjustment of the normal of the disc to be parallel to said axle.

In an embodiment of the invention, the control signal is a signal having a DC component and an AC component having a periodicity corresponding to a rotation speed of said disc and an amplitude related to said distance. The method further comprises: operating said tilt means in a first and second direction for minimizing said amplitude. The method may further comprise operating said tilt means in an X-direction for minimizing said amplitude; and operating said tilt means in a Y-direction for further minimizing said amplitude; and optionally repeating said procedure.

In another embodiment, the method may further comprise directing a beam of a light source, such as a laser, at said disc via a lens assembly comprising a solid immersion lens; and controlling the distance of said solid immersion lens to be very close to the surface of said disc by means of an actuator controlled by an error signal.

Further objects, features and advantages of the present invention will appear from the following detailed description of embodiments of the invention with references to the appending drawings, in which:

FIGS. 1 a, b, c are optical diagrams of a lens included in a disc drive.

FIG. 2 is a cross-sectional view of disc drive according to prior art.

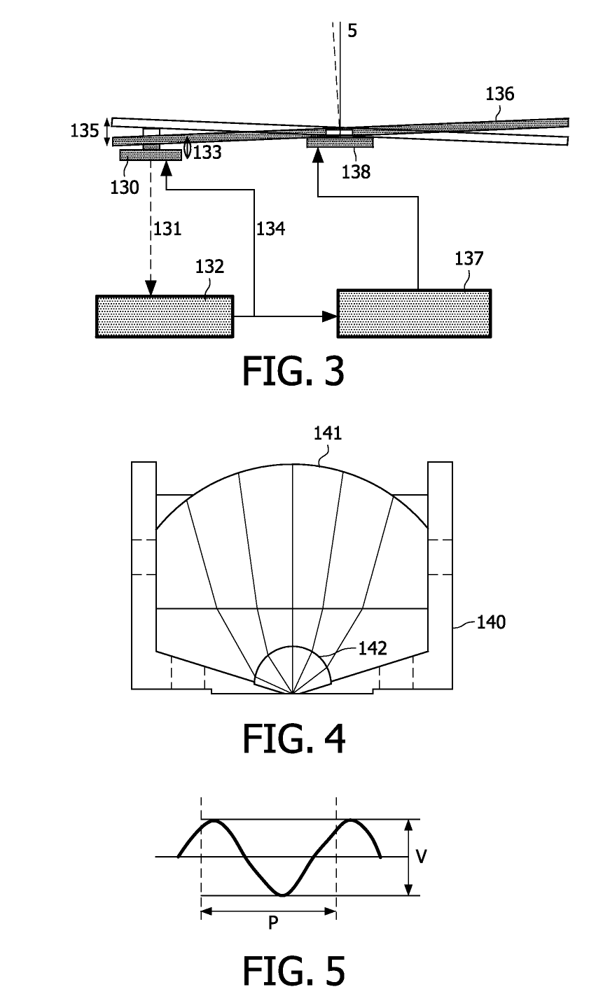

FIG. 3 is a partially schematic cross-sectional view of the disc drive of FIG. 2, in which the present invention is used.

FIG. 4 is an optical diagram of the lens assembly according to the invention.

FIG. 5 is a diagram of a gap control signal.

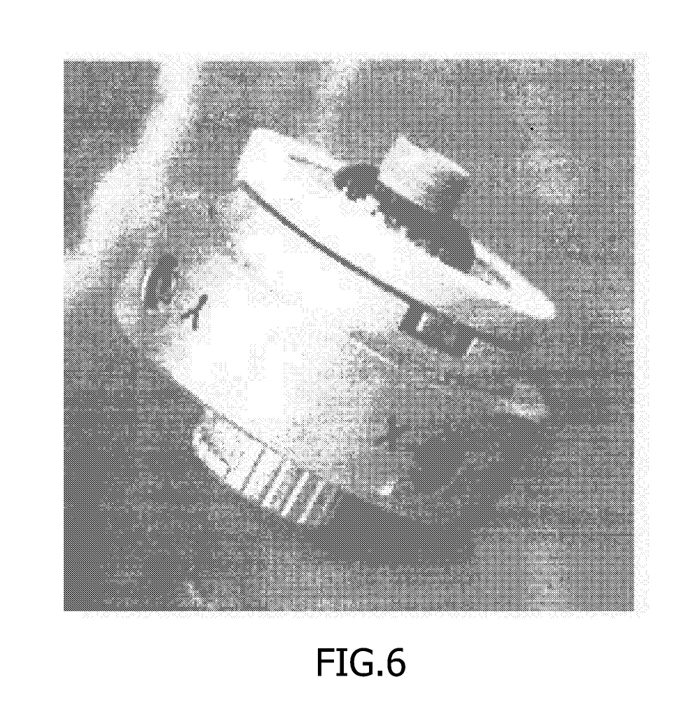

FIG. 6 a picture of an example of a disc clamp with a skew correction arrangement.

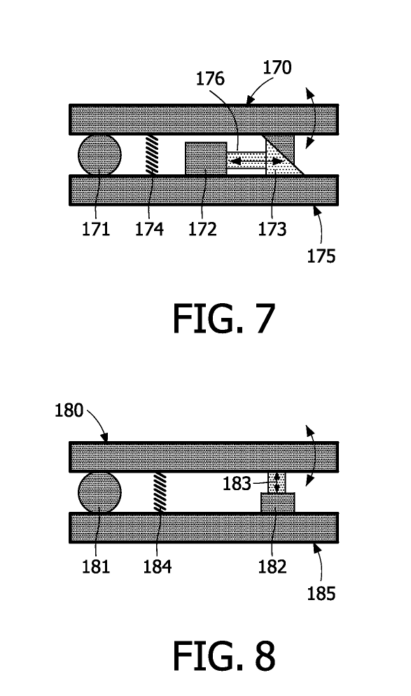

FIG. 7 is a cross-sectional view of a tilt actuator according to an embodiment of the invention.

FIG. 8 is a cross-sectional view of a tilt actuator according to another embodiment of the invention.

FIG. 2 schematically illustrates an optical disc drive apparatus 1, suitable for writing information on or reading information from an optical disc 2. The disc drive 1 comprises a frame 3. The disc drive also comprises a motor 4 fixed to the frame 3, defining a rotation axis 5, for rotating the disc 2. For receiving and holding the disc 2, the disc drive 1 comprises a turntable and a clamping hub 6, which in the case of a spindle motor 4 is mounted on a spindle axle 7 of the motor 4.

The disc drive 1 also comprises a displaceable sledge 10, which is displaceable guided in the radial direction of the disc 2, perpendicular to the rotation axis 5, by guiding means, not shown. A radial sledge actuator 11 is designed to regulate the radial position of the sledge 10 with respect to the frame 3. The actuator constitutes a radial coupling 12 between sledge 10 and frame 3, which is elastic. The disc drive further comprises a platform 20 displaceable in the radial direction with respect to the sledge 10. A radial platform actuator 21 constitutes a radial coupling 22 between the platform 20 and the sledge 10, which is elastic. Since the disc drive apparatus 1 generally is constructed according to prior art and not a subject of the invention, further details thereof are not disclosed. The above description of the disc drive is only for the sake of clarity.

FIG. 3 schematically shows the part of the disc drive of FIG. 2 that is the subject of the invention. An air gap actuator 130 is mounted in a so-called optical pick-up unit (OPU), not shown, together with a number of optical elements. The OPU is placed in the platform 20. The OPU can be moved at least in a radial direction to address different locations on the disc, as described above, similar as in all CD and DVD drives.

The air gap actuator 130 contains a near field lens assembly, which is shown in FIG. 4. The lens assembly comprises a focus lens 141 and a solid immersion lens SIL 142, which are mounted in a lens holder 140. As demonstrated by Sony in paper [T. Ishimoto et al. Proceedings of Optical Data-Storage 2001 in Santa Fe], a good gap error signal 131 is obtained from the reflected light with perpendicular polarization (integrated intensity of ‘Malthese cross’) in the lens assembly. This gap error signal 131 is used in a gap servo system 132 to maintain the air gap distance 133 between the SIL 142 and the disc 136. The gap servo system 132 uses the gap error signal 131 as input to produce a well-behaved (fast response, no overshoot, etc.) gap control signal 134 that is sent back to the air gap actuator 130 in order to follow the disc run out 135, by moving the lens assembly in the axial direction. Inside the actuator 130, a pair of permanent magnets in combination with electromagnetic coils usually does this: by changing the current through the coils, they (and the lens assembly) will move in the focus direction. Another embodiment involves e.g. piezo actuators. Thus, the distance between the lens assembly (to be exact, the exit surface of the SIL) and the entrance face of the disc 136 is maintained at a predefined value (and within specified limits). When the disc moves in the axial direction, e.g. due to run out 135, the lens assembly will be guided by the gap servo system 132 to nicely follow the disc 136. Since the air gap actuator 130 displacement normally is proportional to the gap control signal 134, this signal is a direct measure of the run out 135. Thus, the peak-to-peak value V of this signal, which is shown in FIG. 5, after at least one revolution of the disc (period P) is an excellent error signal for the disc run out 135.

This gap control signal 134 is used as input to a common control circuit 137. In the literature on control systems, many possible implementations are known. The control circuit 137 generates a control signal or combination of control signals to drive a skew correction head 138 in such a way that the gap control signal 134, see FIG. 5, is minimized.

For this method to work, the lens 141 needs to come into the near field region, i.e. within about 1/10^{th} of the wavelength of the laser light, between 290 nm (professional laser system) and 780 nm, more especially 405 nm. To accomplish this some conditions need to be fulfilled: the disc 136 should be aligned with respect to the lens 141 within the mechanical tilt margin of the lens 141, which is typically 1 to several mrad. This can be done e.g. by a reasonably accurate clamping mechanism, which guarantees the alignment. For commercial drives, however, this would require some modifications, e.g. Blu-ray Discs have a run out of less than 100 μm, which corresponds to about 0.5 mrad. The limited clamping accuracy increases this run out even further.

FIG. 6 shows a disc clamp, which may be used in the present invention, with an arrangement for modifying the tilting in X and Y directions. A skew table that can be operated manually by adjusting two screws, marked X and Y, on the front side. The screws operate two small levers that provide the tilting action of the table with respect to the motor axis in two independent directions.

An electrically controlled skew correction mechanism can be based on a variety of principles e.g. electromagnetic, piezoelectric. All these methods can be used to provide an electrically controlled tilting action. Many variations are possible, some examples are schematically shown in FIGS. 7 and 8.

FIG. 7 schematically shows an implementation example of a tilt actuator using a lever-type of tilt arrangement. The disc is for example mounted on the top plate 170, 180, and the motor axle 172, 182 is attached to the bottom plate 175, 185. Both plates are kept together by a spring 174, 184 and can rotate over a ball joint 171, 181. An electrically controlled device 172, 182 such as a motor, an electromagnetic or a piezoelectric actuator that drives a wedge 173 attached to a linear shaft 176 performs the tilting action. Movement of this wedge 173 will cause the top plate 170 to tilt with respect to the bottom plate 175.

An alternative tilt actuator is shown in FIG. 8, where the electrically controlled device 182 drives a shaft 183 directly against the top plate 180 to provide the tilting action.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Above, the invention has been described in relation to certain embodiment shown on the drawings. However, such embodiments do not limit the invention but are only for illustrating the invention. The invention may be modified and completed in different manners as occurs to a person reading the specification and such modifications are intended to be within the scope of the invention. The invention is only limited by the appended patent claims.

1. A device for controlling disc run out in an optical disc drive system, comprising:
a rotatable axle (7);
a holding means (6) arranged at said axle for holding a disc (2, 136) so that a normal of the disc is essentially parallel to said axle;
a tilt means (138) arranged at said holding means for tilting the disc;
a collection unit (10) arranged at the optical disc drive for reading information from or writing information to the disc;
a servo means (132) for maintaining said collection unit at a distance (133) from said disc, said servo means producing a control signal (134);
characterized by
a control means (137) for controlling the tilt means (138) by means of said control signal (134) for adjustment of the normal of the disc (2, 136) to be parallel to said axle (7).

2. The device of claim 1, wherein
said control signal (134) is a signal having a DC component and an AC component having a periodicity corresponding to a rotation speed of said disc and an amplitude related to said distance;
said control means (137) controlling said tilt means (138) in a first and second direction for minimizing said amplitude.

3. The device of claim 2, wherein said control means (137) controls said tilt means (138) in an X-direction for minimizing said amplitude and then controls said tilt means in a Y-direction for further minimizing said amplitude, and optionally repeating this procedure.

4. The device of claim 1, in which
said collection unit (10) comprises a light source, such as a laser, and a lens assembly for directing a beam of said light source at said disc,
said lens assembly comprising a solid immersion lens (SIL) (142) being controlled to be very close to the surface of said disc (2, 136) by an actuator (130) controlled by an error signal (131).

5. A method of controlling disc run out in an optical disc drive system, in which said optical disc drive system comprises:
a rotatable axle (7);
a holding means (6) arranged at said axle for holding a disc (2, 136) so that a normal of the disc is essentially parallel to said axle;
a tilt means (138) arranged at said holding means for tilting the disc;
a collection unit (10) arranged at the optical disc drive for reading information from or writing information to the disc;
characterized by
maintaining said collection unit at a distance (133) from said disc by means of a servo system (132) producing a control signal (134);
providing said control signal to said tilt means for adjustment of the normal of the disc to be parallel to said axle.

6. The method of claim 1, wherein
said control signal (134) is a signal having a DC component and an AC component having a periodicity corresponding to a rotation speed of said disc (2, 136) and an amplitude related to said distance;
the method further comprising:
operating said tilt means (138) in a first and second direction for minimizing said amplitude.

7. The method of claim 6, comprising
operating said tilt means (138) in an X-direction for minimizing said amplitude;
operating said tilt means in a Y-direction for further minimizing said amplitude; and
optionally repeating said procedure.

8. The method of claim 5, further comprising:
directing a beam of a light source, such as a laser, at said disc via a lens assembly comprising a solid immersion lens (142); and
controlling the distance (133) of said solid immersion lens to be very close to the surface of said disc by means of an actuator (130) controlled by an error signal (131).
